(19) United States
(12) Patent Application Publication
(10) Pub. No.: US 2024/0341222 A1
(43) Pub. Date: Oct. 17, 2024

(54) AGRICULTURAL HEADER WITH A PIVOT SENSOR LINKAGE

(71) Applicant: CNH Industrial America LLC, New Holland, PA (US)

(72) Inventors: Douglas D. Sorensen, II, Lancaster, PA (US); Felipe Ramina, Curitiba (BR); Cory D. Hunt, Millersville, PA (US); Jethro Martin, Ephrata, PA (US)

(21) Appl. No.: 18/682,299

(22) PCT Filed: Aug. 9, 2022
(86) PCT No.: PCT/US22/39775

§ 371 Date: Feb. 8, 2024

Related U.S. Application Data
(60) Provisional application No. 63/230,954, filed on Aug. 9, 2021.

(51) Int. Cl. A01D 34/28; A01D 41/14

(52) U.S. Cl. CPC A01D 34/283; A01D 41/141

(57) ABSTRACT

A header for an agricultural vehicle includes: a header frame; a flexible cutter supported by the header frame and including a plurality of cutting edges; a support arm coupled to the flexible cutter and pivotable with respect to the header frame; and a sensor assembly including a pivot sensor directly coupled to the support arm and a linkage including a linkage arm coupled to the pivot sensor and the support arm such that pivoting of the support arm also causes pivoting of the linkage arm, the pivot sensor being configured to output a total pivot angle signal corresponding to a pivot angle of the support arm plus an additional pivot angle of the linkage arm when the support arm and the linkage arm pivot.

### FIELD OF THE INVENTION

The present invention pertains to an agricultural vehicle and, more specifically, to a header for an agricultural vehicle which includes a pivot sensor for a support arm.

### BACKGROUND OF THE INVENTION

An agricultural harvester known as a “combine” is historically termed such because it combines multiple harvesting functions with a single harvesting unit, such as picking, threshing, separating and cleaning. A combine includes a header which removes the crop from a field, and a feeder housing which transports the crop matter into a threshing rotor. The threshing rotor rotates within a perforated housing, which may be in the form of adjustable concaves and performs a threshing operation on the crop to remove the grain. Once the grain is threshed it falls through perforations in the concaves onto a grain pan. From the grain pan the grain is cleaned using a cleaning system, and is then transported to a grain tank onboard the combine. A cleaning fan blows air through the sieves to discharge chaff and other debris toward the rear of the combine. Non-grain crop material such as straw from the threshing section proceeds through a residue system, which may utilize a straw chopper to process the non-grain material and direct it out the rear of the combine. When the grain tank becomes full, the combine is positioned adjacent a vehicle into which the grain is to be unloaded, such as a semi-trailer, gravity box, straight truck, or the like; and an unloading system on the combine is actuated to transfer the grain into the vehicle.

To remove crop material from the field, the header of the combine harvester may be equipped with a cutter, such as a cutter bar assembly, having many sharp cutting elements that reciprocate sidewardly, relative to a forward direction of travel, to sever the crop material from the field before entering the feeder housing. The header may also include a rotating reel with tines or the like to sweep crop material toward the cutting elements.

To better follow the ground during harvesting, many headers include a flexible cutter bar assembly which can flex during travel of the vehicle to more closely follow the contour of the ground when, for example, the vehicle encounters uneven terrain. To flex, the cutter bar assembly may include one or more flexible segments which carry the cutting elements and are connected to support arms which can move up and down responsively to forces from the ground, which causes flexing of the flexible segments and vertical movement of the carried cutting elements. Knowing the pivot angle of the support arms is important for controlling the header but it is difficult to reliably and accurately measure the pivot angle of the support arms.

What is needed in the art is a way to reliably and accurately measure the pivot angle of a support arm of a header.

### SUMMARY OF THE INVENTION

In one exemplary embodiment formed in accordance with the present invention, there is provided a sensor assembly with a pivot sensor that is directly coupled to a support arm and is coupled to a linkage arm such that pivoting of the support arm causes pivoting of the linkage arm and the pivot sensor can output a total pivot angle signal corresponding to a pivot angle of the support arm plus an additional pivot angle of the linkage arm when the support arm and the linkage arm pivot.

In some exemplary embodiments formed in accordance with the present invention, there is provided a header for an agricultural vehicle including: a header frame; a flexible cutter supported by the header frame and including a plurality of cutting edges; a support arm coupled to the flexible cutter and pivotable with respect to the header frame; and a sensor assembly including a pivot sensor directly coupled to the support arm and a linkage including a linkage arm coupled to the pivot sensor and the support arm such that pivoting of the support arm also causes pivoting of the linkage arm, the pivot sensor being configured to output a total pivot angle signal corresponding to a pivot angle of the support arm plus an additional pivot angle of the linkage arm when the support arm and the linkage arm pivot.

In some exemplary embodiments formed in accordance with the present invention, there is provided an agricultural vehicle including a chassis and a header carried by the chassis. The header includes: a header frame; a flexible cutter supported by the header frame and including a plurality of cutting edges; a support arm coupled to the flexible cutter and pivotable with respect to the header frame; and a sensor assembly including a pivot sensor directly coupled to the support arm and a linkage including a linkage arm coupled to the pivot sensor and the support arm such that pivoting of the support arm also causes pivoting of the linkage arm, the pivot sensor being configured to output a total pivot angle signal corresponding to a pivot angle of the support arm plus an additional pivot angle of the linkage arm when the support arm and the linkage arm pivot.

One possible advantage of exemplary embodiments provided in accordance with the present invention is that the pivot sensor being configured to output the total pivot angle signal can allow the pivot sensor to output pivot angle signals that are closer to the normal operating range of the pivot sensor even when the pivot angle of the support arm is relatively small.

Another possible advantage of exemplary embodiments provided in accordance with the present invention is that the linkage can be used in areas with small open spaces, such as in headers that include one or more draper belts.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1 illustrates a top view of an exemplary embodiment of an agricultural vehicle, the agricultural vehicle including a chassis and a header provided according to the present disclosure;

FIG. 2A illustrates an exemplary embodiment of a support arm and a sensor assembly including a linkage provided according to the present disclosure;

FIG. 2B illustrates the support arm and the sensor assembly of FIG. 2A after the support arm has pivoted;

FIG. 3A illustrates another exemplary embodiment of a support arm and a sensor assembly including a linkage provided according to the present disclosure;

FIG. 3B illustrates the support arm and the sensor assembly of FIG. 3A after the support arm has pivoted;

FIG. 4A illustrates another exemplary embodiment of a support arm and a sensor assembly including a linkage provided according to the present disclosure; and

FIG. 4B illustrates the support arm and the sensor assembly of FIG. 4A after the support arm has pivoted.

### DETAILED DESCRIPTION OF THE INVENTION

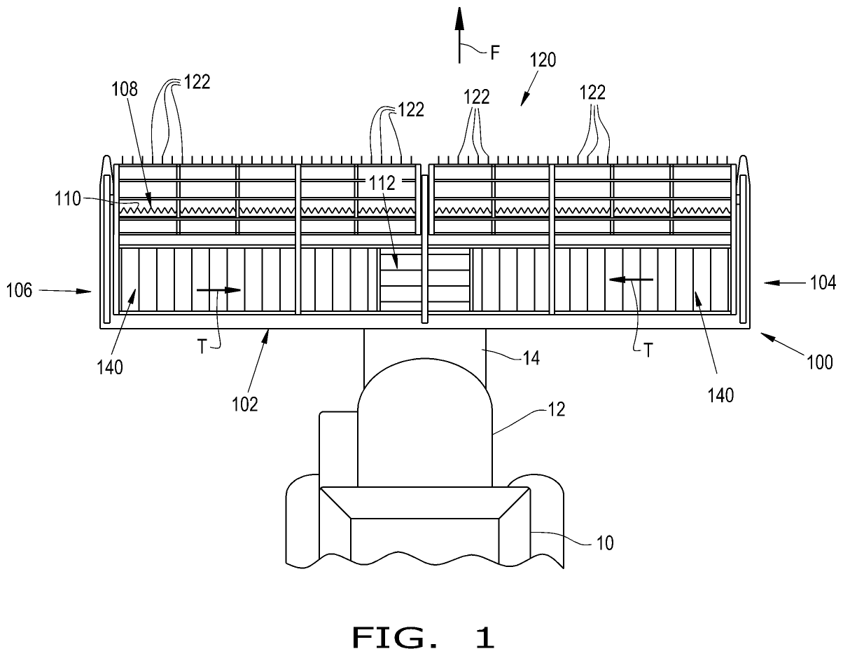

Referring now to the drawings, and more particularly to FIG. 1, there is shown an exemplary embodiment of an agricultural vehicle 10 in the form of a combine harvester which generally includes a chassis 12, a feeder housing 14, and an attachment in the form of a header 100. Typically, the combine harvester 10 will include additional internal systems for the separation and handling of collected crop material, but these additional systems are omitted from view for brevity of description. It should be appreciated that the header 100 described and illustrated herein does not necessarily need to be included on combine harvesters, but can be incorporated in other agricultural vehicles such as windrowers. Further, while the exemplary embodiment of the header 100 is shown and described as a draper header, it should be appreciated that the header can be formed, in some exemplary embodiments, as an auger-type header incorporating one or more augers as the crop material conveyor(s).

The header 100 is coupled to the feeder housing 14 and carried by the chassis 12 of the agricultural vehicle 10. The header 100 has a header frame 102 and a pair of opposed lateral ends 104, 106. The header frame 102 supports one or more flexible cutters 108, shown as a cutter bar, with reciprocating cutting edges 110 to cut crop material as the agricultural vehicle 10 travels in a forward direction, denoted by arrow F. The header 100 may further include a center feed belt 112 or a center auger that conveys the crop material into the feeder housing 14. In one exemplary embodiment, the header 100 can include one or more conveyors in the form of lateral, flexible draper belts 140 that are positioned rearwardly of the cutter bar(s) 108 and travel, i.e. rotate, in opposing directions of travel, denoted by each arrow “T”, in order to convey the crop material inwardly to the center feed belt 112 and thereby the feeder housing 14. In some exemplary embodiments, the header 100 may include a pair of cross augers, rather than the draper belts 140, to convey crop material laterally inward toward the center feed belt 112.

The header 100 includes a rotating reel 120. The reel 120 includes a plurality of tines 122 or the like to sweep crop material inwardly toward the flexible cutter(s) 108 for cutting as the reel 120 rotates. The reel 120 may be formed as a unified reel with a single reel section or, in some embodiments, as a segmented reel including a plurality of reel sections.

In many known headers, the cutter, such as a cutter bar, is supported by one or more support arms that can pivot with respect to the header frame in order to support the cutter during flexing. The pivot angle of the support arm(s) can be a useful input for control of the header, e.g., for automatic header height control. However, the maximum pivot angle of the support arm(s) may be relatively small, such as less than 10°. Such a relatively small pivot angle can be difficult for a pivot angle sensor to measure due to the pivot angle sensor being configured to measure pivot angles that are substantially larger, e.g., around 60° or more. In such instances, the pivot angle sensor may be unable to reliably and/or accurately measure the pivot angle of the support arm.

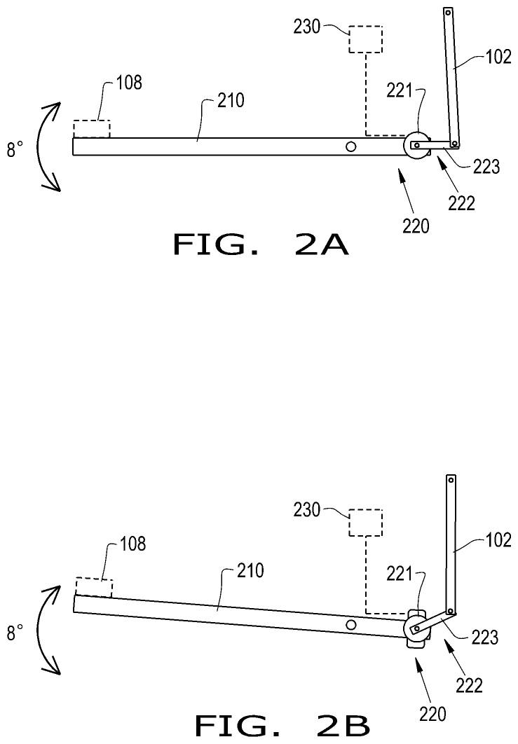

Referring now to FIGS. 2A and 2B, a support arm 210 is illustrated that is coupled to the flexible cutter 108 and is pivotable with respect to the header frame 102. A sensor assembly 220 is provided that includes a pivot sensor 221 directly coupled to the support arm 210 and a linkage 222 including a linkage arm 223 that is coupled to the pivot sensor 221 and the support arm 210. As illustrated in FIGS. 2A and 2B, the linkage arm 223 is coupled to the pivot sensor 221 and the support arm 210 such that pivoting of the support arm 210 also causes pivoting of the linkage arm 223. As illustrated in FIG. 2B, the pivoting of the support arm 210 and the linkage arm 223 causes the linkage arm 223 to pivot by a total pivot angle that is equal to a pivot angle of the support arm 210 plus an additional pivot angle of the linkage arm 223 when the support arm 210 and the linkage arm 223 pivot. The pivot sensor 221 is configured to output a total pivot angle signal that corresponds to the total pivot angle, i.e., that corresponds to the pivot angle of the support arm 210 plus the additional pivot angle of the linkage arm 223, when the support arm 210 and the linkage arm 223 pivot.

The additional pivot angle of the linkage arm 223 is correlated to the pivot angle of the support arm 210 due to various geometric parameters of the linkage arm 223 and how the linkage arm 223 is coupled to the support arm 210. The additional pivot angle is designated as x° in FIG. 2B to signify that the additional pivot angle x° can be varied as a function of the pivot angle of the support arm 210. When the support arm 210 pivots by a pivot angle of, for example, 8°, the total pivot angle of the linkage arm 223 may be equal to x°+8°, signifying that the total pivot angle is equal to the pivot angle of the support arm 210 (8°) plus the additional pivot angle of the linkage arm 223 (x°). Thus, the total pivot angle measured by the pivot sensor 221 is equal to x°+8°, so the corresponding total pivot angle signal output by the pivot sensor 221 will correspond to a pivot angle value that is greater than just the pivot angle of the linkage arm 223 and may be closer to the typical angle value that the pivot sensor 221 is configured to measure. It should be appreciated that the geometry of the linkage arm 223, e.g., a length of the linkage arm 223, may be adjusted so the additional pivot angle of the linkage arm 223 that is added to the pivot angle of the support arm 210 results in a total pivot angle that is within an optimal operating range of the pivot sensor 221. In some embodiments, the linkage 222 is configured so the additional pivot angle is between 40° and 80°.

The pivot sensor 221 may be operably coupled to a controller 230, which is configured to receive the total pivot angle signal and determine the pivot angle of the support arm 210 based at least partially on the total pivot angle signal. For example, the controller 230 may be configured to determine the pivot angle of the support arm 210 based on the total pivot angle signal by utilizing an algorithm corresponding to a known relationship between the measured total pivot angle and the pivot angle of the support arm 210. After the controller 230 receives the total pivot angle signal, the controller 230 can utilize the algorithm to determine the pivot angle of the support arm 210. Alternatively, the controller 230 can be calibrated by pivoting the support arm 210 through a range of pivot angles so the pivot sensor 221 outputs a plurality of total pivot angle signals to the controller 230, with the controller 230 being configured to associate a respective pivot angle of the support arm 210 with each of received total pivot angle signals. In this respect, measuring the total pivot angle with the pivot sensor 221, rather than just the pivot angle of the support arm 210, can lead to a more accurate and reliable measurement of the pivot angle of the support arm 210 by measuring an angle value (the total pivot angle value) that is closer to the normal operating range of the pivot sensor 221 and then determining the pivot angle of the support arm 210 from the total pivot angle value.

In some embodiments, such as the embodiment illustrated in FIGS. 2A and 2B, the linkage arm 223 is directly coupled to the pivot sensor 221 and the header frame 102. Owing to the pivot sensor 221 being directly coupled to the support arm 210, the linkage arm 223 may be coupled to the support arm 210 via the pivot sensor 221, i.e., the pivot sensor 221 is part of a coupling between the support arm 210 and the linkage arm 223 in addition to measuring the total pivot angle. The pivot sensor 221 may be, for example, a potentiometer or a Hall effect sensor, but it should be appreciated that many types of pivot sensors are known that can be used to measure the total pivot angle.

As can be appreciated from the foregoing description and FIGS. 2A and 2B, the linkage 222 provided according to the present disclosure can be a compact linkage that includes a linkage arm 223 directly coupled to both the pivot sensor 221 and the header frame 102. Such a compact linkage can be utilized in areas that have relatively limited free space, e.g., in a draper header that includes one or more draper belts 140. However, it should be appreciated that other types of linkages may be provided according to the present disclosure.

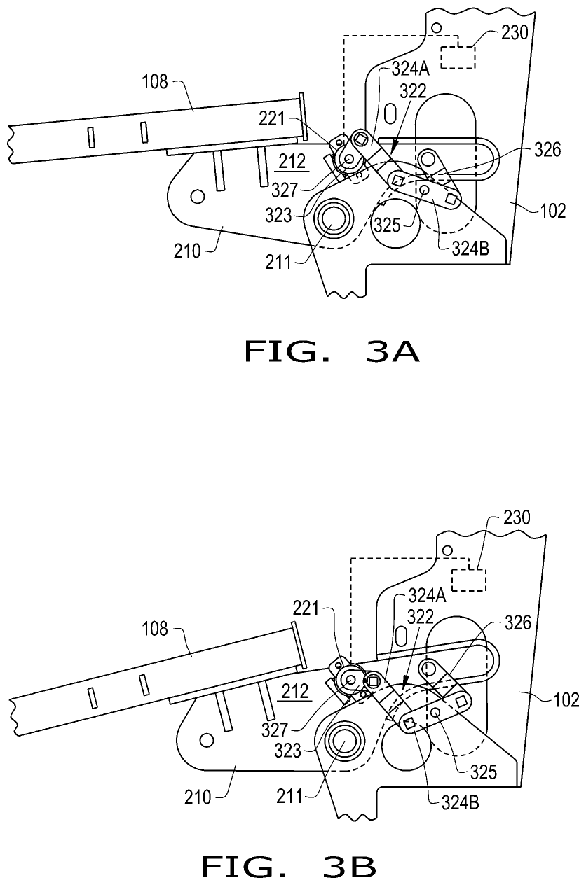

Referring now to FIGS. 3A and 3B, another exemplary embodiment of a linkage 322 provided according to the present disclosure is illustrated that is coupled to the pivot sensor 221 and the support arm 210. The support arm 210 pivots about a support arm pivot 211. The linkage 322 includes a linkage arm 323 that is directly coupled to the pivot sensor 221, but the linkage arm 323 is not directly coupled to the header frame 102. Rather, the linkage 322 includes at least one intermediary bar, illustrated as a plurality of intermediary bars 324A, 324B, with one or more of the intermediary bars 324A, 324B coupling the linkage arm 323 to the header frame 102. As illustrated, the intermediary bars 324A, 324B couple the linkage arm 323 to the header frame 102, with the intermediary bar 324A coupling the linkage arm 323 to the intermediary bar 324B, which is pivotably coupled to the header frame 102 at a pivot 325. The linkage 322 may also include an arm linkage bar 326 that couples the intermediary bar 324B to the support arm 210. The linkage 322 may thus form a four-bar linkage. As illustrated, the linkage arm 323 may couple to the pivot sensor 221 at a pivot 327 defining a pivot axis that extends through the support arm 210 due to the pivot sensor 221 being mounted to a side surface 212 of the support arm 210. As can be appreciated from a comparison of FIGS. 3A and 3B, the linkage 322 including the intermediary bars 324A and 324B and the arm linkage bar 326 can cause an even greater total pivot angle to be measured by the pivot sensor 221 compared to the linkage 222 due to the linkage arm 323 being further pivoted by the coupling to the support arm 210 via the arm linkage bar 326 and the intermediary bars 324A, 324B.

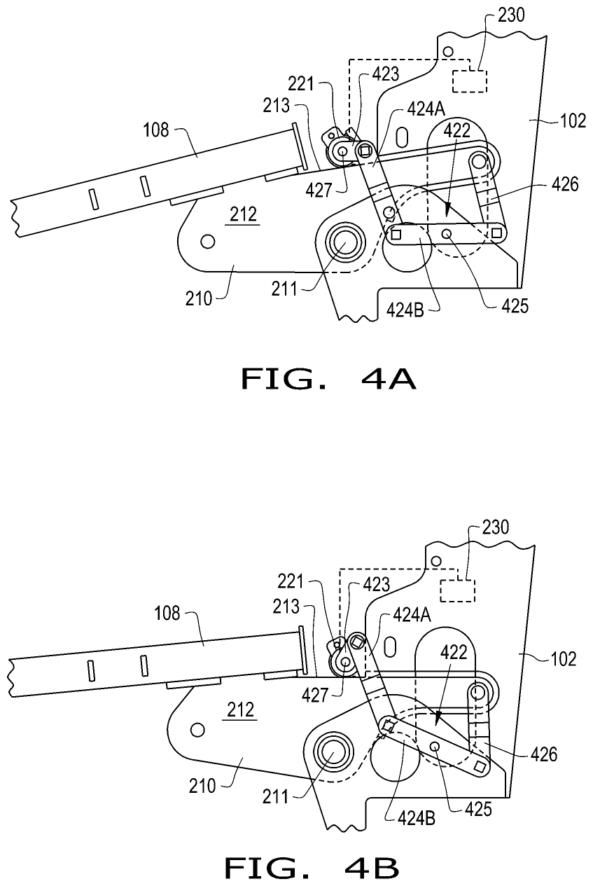

Referring now to FIGS. 4A and 4B, another exemplary embodiment of a linkage 422 provided according to the present disclosure is illustrated that is coupled to the pivot sensor 221 and the support arm 210. Similarly to the linkage 322 of FIGS. 3A and 3B, the linkage 422 includes a linkage arm 423 that is directly coupled to the pivot sensor 221 and a plurality of intermediary bars 424A, 424B coupling the linkage arm 423 to the header frame 102. The linkage 422 also includes an arm linkage bar 426 that couples the intermediary bar 424B, which is pivotably coupled to the header frame 102 at a pivot 425, to the support arm 210. As can be appreciated from a comparison of FIGS. 4A and 4B to FIGS. 3A and 3B, the linkage 422 has intermediary bars 424A, 424B and an arm linkage bar 426 that are elongated relative to the intermediary bars 324A, 324B and the arm linkage bar 326, respectively, due to the pivot sensor 221 coupling to a top surface 213 of the support arm 210 rather than the side surface 212. Similarly, the linkage arm 423 may be coupled to the pivot sensor 221 at a pivot 427 that defines a pivot axis that does not extend through the support arm 210. Elongating the intermediary bars 424A, 424B and the arm linkage bar 426 of the linkage 422 can result in a greater additional pivot angle compared to the linkage 322 so the pivot sensor 221 measures a greater total pivot angle when the support arm 210 and the linkage arm 423 pivot. In other respects, the linkage 422 may be similar to the previously described linkage 322.

From the foregoing, it should be appreciated that the linkage 222, 322, 422 provided according to the present disclosure can increase the accuracy and reliability of the pivot sensor 221 by causing the pivot sensor 221 to measure pivot angles that are closer to the normal sensing range of the pivot sensor 221. The provided linkage, such as the linkage 222, can be compact for use in areas of the header 100 where space is limited. The provided linkage, such as either of the linkages 322, 422, can also be configured to create relatively large additional pivot angles of the linkage arm 323, 423 and produce a relatively large total pivot angle. Thus, it should be appreciated that the linkage 222, 322, 422 provided according to the present disclosure can be configured in a variety of ways to increase the total pivot angle measured by the pivot sensor 221 to accurately and reliably measure the pivot angle of the support arm 210.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. A header for an agricultural vehicle, comprising:
a header frame;
a flexible cutter supported by the header frame and including a plurality of cutting edges;
a support arm coupled to the flexible cutter and pivotable with respect to the header frame; and
a sensor assembly comprising a pivot sensor directly coupled to the support arm and a linkage comprising a linkage arm coupled to the pivot sensor and the support arm such that pivoting of the support arm also causes pivoting of the linkage arm, the pivot sensor being configured to output a total pivot angle signal corresponding to a pivot angle of the support arm plus an additional pivot angle of the linkage arm when the support arm and the linkage arm pivot.

2. The header of claim 1, wherein the linkage arm is directly coupled to the pivot sensor.

3. The header of claim 2, wherein the linkage arm is directly coupled to the header frame.

4. The header of claim 2, wherein the linkage arm is coupled to the support arm via the pivot sensor.

5. The header of claim 2, wherein the linkage comprises at least one intermediary linkage bar coupling the linkage arm to the header frame.

6. The header of claim 5, wherein the at least one intermediary linkage bar comprises a plurality of intermediary linkage bars.

7. The header of claim 5, wherein the linkage comprises an arm linkage bar coupling the at least one intermediary linkage bar to the support arm.

8. The header of claim 1, further comprising a controller operably coupled to the pivot sensor, the controller being configured to receive the total pivot angle signal and determine the pivot angle of the support arm based at least partially on the total pivot angle signal.

9. The header of claim 1, further comprising at least one conveyor carried by the header frame.

10. An agricultural vehicle, comprising:
a chassis; and
a header carried by the chassis, the header comprising:
a header frame;
a flexible cutter supported by the header frame and including a plurality of cutting edges;
a support arm coupled to the flexible cutter and pivotable with respect to the header frame; and
a sensor assembly comprising a pivot sensor directly coupled to the support arm and a linkage comprising a linkage arm coupled to the pivot sensor and the support arm such that pivoting of the support arm also causes pivoting of the linkage arm, the pivot sensor being configured to output a total pivot angle signal corresponding to a pivot angle of the support arm plus an additional pivot angle of the linkage arm when the support arm and the linkage arm pivot.

11. The agricultural vehicle of claim 10, wherein the linkage arm is directly coupled to the pivot sensor.

12. The agricultural vehicle of claim 11, wherein the linkage arm is directly coupled to the header frame.

13. The agricultural vehicle of claim 11, wherein the linkage arm is coupled to the support arm via the pivot sensor.

14. The agricultural vehicle of claim 11, wherein the linkage comprises at least one intermediary linkage bar coupling the linkage arm to the header frame.

15. The agricultural vehicle of claim 14, wherein the at least one intermediary linkage bar comprises a plurality of intermediary linkage bars.

16. The agricultural vehicle of claim 14, wherein the linkage comprises an arm linkage bar coupling the at least one intermediary linkage bar to the support arm.

17. The agricultural vehicle of claim 10, further comprising a controller operably coupled to the pivot sensor, the controller being configured to receive the total pivot angle signal and determine the pivot angle of the support arm based at least partially on the total pivot angle signal.

18. The agricultural vehicle of claim 10, wherein the header comprises at least one conveyor carried by the header frame.

19. The agricultural vehicle of claim 18, wherein the at least one conveyor comprises at least one draper belt.

20. The agricultural vehicle of claim 10, further comprising a feeder housing carried by the chassis, the header being coupled to the feeder housing.
